(19) United States
(12) Patent Application Publication
(10) Pub. No.: US 2015/0139756 A1
(43) Pub. Date: May 21, 2015

(54) TRANSPORT ASSIST APPARATRUS

(71) Applicant: KABUSHIKI KAISHA TOSHIBA, Tokyo (JP)

(72) Inventors: Daisuke Yamamoto, Kawasaki (JP); Atsushi Sadamoto, Yokohama (JP); Hideichi Nakamoto, Tokyo (JP); Junya Tanaka, Tokyo (JP); Haruna Eto, Kawasaki (JP)

(21) Appl. No.: 14/548,564

(22) Filed: Nov. 20, 2014

(30) Foreign Application Priority Data
Nov. 20, 2013 (JP) 2013-240065
Oct. 22, 2014 (JP) 2014-215671

(51) Int. Cl. B25J 1/02

(52) U.S. Cl. CPC B25J 1/02
USPC 414/4

(57) ABSTRACT

According to one embodiment, a transport assist apparatus includes a backpack, a straight-move support unit and a drive unit. The straight-move support unit is connected to the backpack and includes a support member configured to be driven so as to make an end of the support member contact a floor surface. The drive unit is connected to the backpack and the straight-move support unit and drives the support member in a direction of moving the end toward the floor surface in accordance with lifting up of at least one of a target person and a target object by a user, or in a direction of moving the end away from the floor surface in accordance with setting down of the at least one of the target person and the target object by the user.

### CROSS-REFERENCE TO RELATED APPLICATIONS

This application is based upon and claims the benefits of priority from Japanese Patent Applications No. 2013-240065, filed Nov. 20, 2013, and No. 2014-215671, filed Oct. 22, 2014, the entire contents of all of which are incorporated herein by reference.

### FIELD

Embodiments described herein relate generally to a transport assist apparatus.

### BACKGROUND

Nursing care fields and logistics fields have needs for assistance to transport heavy objects. However, conventional lifters have a structure of solely standing alone to support a full load weight, and are therefore massive in scale, choosy about use location, and require setup preparations before use, which are problems. Therefore, in a small medical room or at a field where various tasks other than lifting tasks are performed in combination, it is difficult to use a lifter in the present circumstances.

On the other hand, there are assist devices capable of saving space, such as, a wearable-type power assist devices attached to joints of a user, and an assist mechanism, a user of which manipulates arms extended from a set of horizontal and vertical members and a main frame linking left and right sides of the mechanism.

### BRIEF DESCRIPTION OF THE DRAWINGS

FIG. 1 is a view illustrating a transport assist apparatus according to a first embodiment;

FIG. 2 illustrates an example of a use state of the transport assist apparatus according to the first embodiment;

FIG. 3 is a block diagram illustrating details of a drive unit according to the first embodiment;

FIG. 4 illustrates a specific example operation of the transport assist apparatus according to the first embodiment;

FIG. 5 illustrates an example of a storing operation of the transport assist apparatus according to the first embodiment;

FIG. 6 illustrates flow of a series of operations from a stored state through an expanding operation up to a lift-up operation according to the first embodiment; and

FIG. 7 illustrates an example of a boarding operation of the transport assist apparatus according to the first embodiment.

FIG. 8A illustrates a first state of a transport assist apparatus according to a second embodiment;

FIG. 8E illustrates a second state of the transport assist apparatus according to the second embodiment;

FIG. 8C illustrates a third state of the transport assist apparatus according to the second embodiment;

FIG. 9 illustrates an initial state of a specific example of a lifting operation of the transport assist apparatus according to the second embodiment;

FIG. 10 illustrates a crouching state of a specific example of the lifting operation of the transport assist apparatus according to the second embodiment;

FIG. 11 illustrates a lifting state of a specific example of the lifting operation of the transport assist apparatus according to the second embodiment;

FIG. 12A illustrates a first state of a transport assist apparatus according to a modification of the second embodiment; and

FIG. 12B illustrates a second state of the transport apparatus according to the modification of the second embodiment.

### DETAILED DESCRIPTION

The wearable-type power assist devices as described above cannot easily be attached but requires laborious handling to attach and further restrains joints of a user to a certain extent, resulting in a problem that it is hard for a user to perform an action or rest. Further, regarding an assist mechanism a user of which manipulates arms extended from a main frame, the user often sets themself in an unnatural position or posture, resulting in a problem that fatigue of the user increases or the user is hindered from exerting their power.

In general, according to one embodiment, a transport assist apparatus includes a backpack, a straight-move support unit and a drive unit. The straight-move support unit is connected to the backpack and includes a support member configured to be driven so as to make an end of the support member contact a floor surface. The drive unit is connected to the backpack and the straight-move support unit and configured to drive the support member in a direction of moving the end toward the floor surface in accordance with lifting up of at least one of a target person and a target object by a user, or in a direction of moving the end away from the floor surface in accordance with setting down of the at least one of the target person and the target object by the user.

### First Embodiment

In the following, the transport assist apparatus according to an embodiment of the present disclosure will be explained with reference to the drawings. In the following embodiments, the explanation of the elements with the same reference numerals will be omitted for brevity as their operations will be the same.

The first embodiment will be described with reference to an example case of use in lifting up and setting down a target person, i.e., to lift up a target person who lies on a bed or to set down the lifted target person. However, the embodiment is not limited to this case but is applicable further to lifting up or setting down a target object, such as a load or baggage.

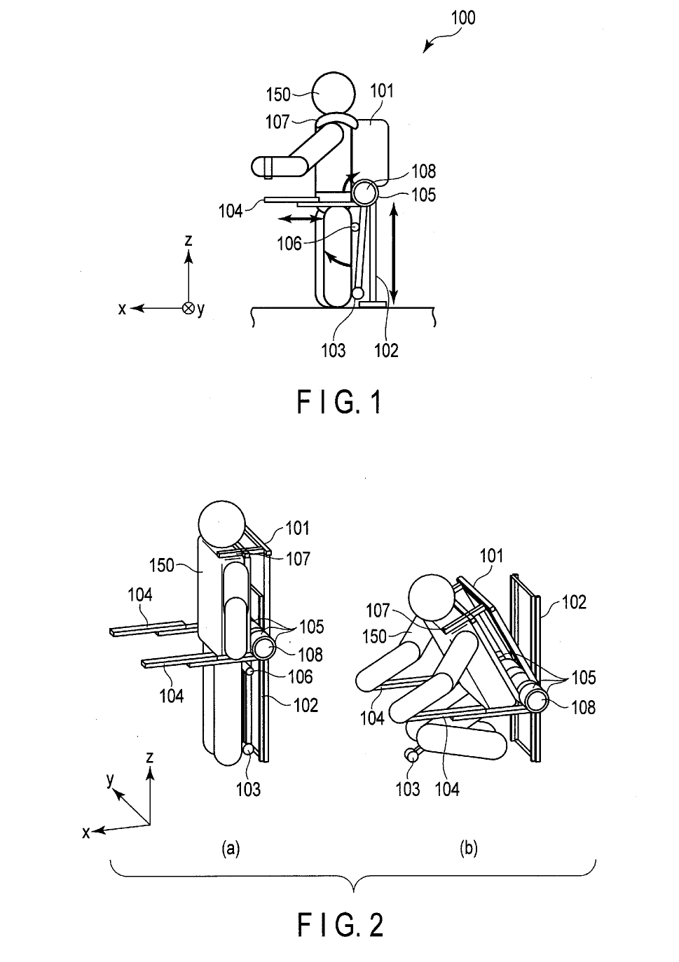

The transport assist apparatus according to the first embodiment will be described with reference to FIG. 1.

The transport assist apparatus 100 according to the first embodiment includes a backpack 101, a straight-move support unit 102, a pivotal support unit 103, an arm support unit 104, a drive unit 105, and a seat 106. Further, the drive unit 105 includes a pivot shaft 108.

The backpack 101 includes shoulder straps 107 on two sides so that a user 150 can carry the apparatus on their back, and a part of the backpack 101 which is, for example, a bottom surface area in contact with a waist portion of the user 150 is connected to the drive unit 105. Further, the backpack 101 can pivot in relation to the straight-move support unit 102. The backpack 101 may include a belt (not shown) to be secured near a waist portion of the user 150 for further secure fixture to the user 150.

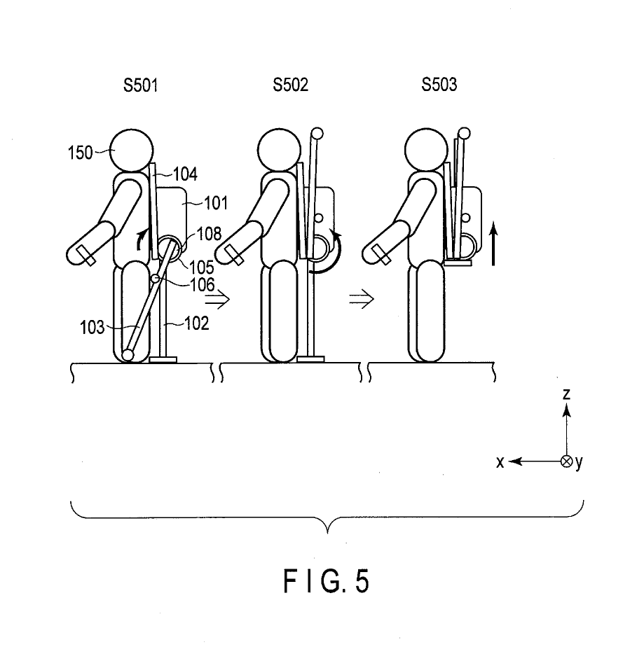

The backpack 101 may be capable of storing internally a power supply (secondary battery) which electrically drives the drive unit 105. Further, the backpack 101 includes a space capable of storing the straight-move support unit 102, pivotal support unit 103, and arm support units 104. A method of storing the straight-move support unit 102, pivotal support unit 103, and arm support units 104 will be described later with reference to FIG. 5.

In a use state, the straight-move support unit 102 is connected to the drive unit 105 and the backpack 101 in a manner that an end of the straight-move support unit 102 contacts with a floor surface, driving along a perpendicular direction to the end from the other end, by the drive unit 105. The straight-move support unit 102 may be formed by providing two perpendicular members (also referred to as support members) in parallel and by connecting horizontal members each to two ends of each of the perpendicular members or may be formed of a perpendicular member. Further, a pivot which can freely rotate about a z-axis may be provided at a part of the straight-move support unit 102 which is brought into contact with the floor surface.

The pivotal support unit 103 is formed of a rod-type member and has an end connected to the drive unit 105 so as to be able to pivot about a y-axis. When the user 150 crouches down in a usage that the user once crouches down and then lifts up a lying a target person or object of a relatively heavy weight, the other end pivots centered on the pivot shaft 108 of the drive unit 105 so as to move toward the forward side of the user 150 (also referred to as an expanding direction) from below the crotch of the user 150, maintaining contact with the floor surface. When the user 150 stands up from a crouching state, the pivotal support unit 103 pivots centered on the pivot shaft 108 of the drive unit 105 so as to move toward the backward side of the user 150 (also referred to as a storing direction).

At the other end which is in contact with the floor surface of the pivotal support unit 103, a wheel having a mechanism which allows free pivoting may be provided or a one-way wheel may be provided which serves as a stopper in the expanding direction and can freely pivot in the storing direction. As well as the wheels, a ball caster or an eccentric caster which is movable not only in forward and backward directions but also in leftward and rightward directions may be provided, or even a simple semispherical shape suffices. Further, the pivotal support unit 103 may have an expandable/contractable structure. As the expandable/contractable structure, a common structure may be employed, and descriptions thereof will be omitted herefrom.

The arm support units 104 each have an end connected to the drive unit 105 and the other end elongated to the forward side of the user 150, and are formed to support forearm parts of the user 150. Although the example of FIG. 1 shows the arm support units 104 each having a rod-type shape, the arm support units 104 each may have any shape such as an angular U-shape or a cylindrical shape insofar as the forearm parts can be supported. Further in the present embodiment, two arm support units 104 are connected to the drive unit 105 so as to respectively support the forearm parts of two arms. The arm support units 104 may be provided with a limiter mechanism (hardware limitation) to limit pivoting of the arm support parts 104 to not greater than a fixed angle (for example, approximately 90 degrees) relative to the straight-move support unit 102. The arm support units 104 may have a shape which expands/contracts to change their length or have a fixed length. Further, the arm support units 104 may be configured to move to the forward or backward side of the user 150, maintaining their lengths constantly. An expandable/contractable structure and a movable structure which are commonly used may be employed as the expandable/contractable structure and movable structure of the arm support unit 104, which will be therefore omitted from the descriptions given below.

Each of the backpack 101, straight-move support unit 102, pivotal support unit 103, and arm support units 104 is connected to the drive unit 105 which is arranged horizontally on a part of the backpack 101, e.g., a bottom surface part of the backpack 101 in this case. The drive unit 105 includes a drive motor, a pinion gear, and a rack gear. The drive unit 105 drives the straight-move support unit 102 to expand/contract by using the drive motor, pinion gear, and rack gear as well as drives the pivotal support unit 103 to pivot about the pivot shaft 108 by using the drive motor and pinion gear.

Specifically, when the user 150 lifts up and sets down a target person or object, the straight-move support unit 102 is expanded and contracted in perpendicular directions by the rack gear through the drive motor and pinion gear so as to support a weight applied to the user 150. Further, the drive unit 105 makes the pivotal support unit 103 pivot centered on the pivot shaft 108 in the expanding direction or the storing direction through the drive motor and pinion gear, in accordance with lifting up and setting down of the target person or object by the user 150. The phrase “support a weight” may be considered as referring to both the weight of the user 150 acting to assist the force of the user 150 to lift up the target person or object, and the capability of supporting the load weight of the target person or object.

A timing at which the drive unit 105 operates when the user 150 lifts up and sets down the target person or object may depend on an instruction from the user 150. Otherwise, a timing when a value of a sensor becomes not smaller than a threshold may be set as the timing for the drive unit 105 to operate. In the present embodiment, the shape of the drive unit 105 is supposed to be a cylindrical shape. Not only the cylindrical shape but also a spherical or prismatic shape or any other shape is available.

The seat 106 is arranged at a part of the pivotal support unit 103. Specifically in the use state, the seat 106 is arranged on the pivotal support unit 103 at a position which allows the user 150 to sit when the user 150 crouches and maintains a half-sitting state. The seat 106 may be provided with a rod-type protrusion to allow the user to perch or may be configured to support most of the weight of the user 150, like a saddle of a bicycle. Alternatively, the seat 106 may be structured such that the seat 106 is not arranged on the pivotal support unit 103 but hangs to the drive unit 105 so as to be capable of pivoting in the expanding direction and is pushed out to allow the user 150 to sit when the pivotal support unit 103 pivots in the expanding direction.

Next, examples of the use state of the transport assist apparatus 100 will be described with reference to FIG. 2

FIG. 2(a) illustrates a state of the transport assist apparatus 100 when the user 150 stands, and FIG. 2(b) illustrates a state of the transport assist apparatus 100 when the user 150 crouches.

As shown in FIG. 2(a), when the user 150 stands, the user 150 carries the backpack 101 on their back, the arm support units 104 horizontally extend toward the forward side of the user 150, and the straight-move support unit 102 and the pivotal support unit 103 extend in a perpendicular direction.

Next, in the state in which the user 150 crouches as shown in FIG. 2(b), the straight-move support unit 102 assists operations of the user 150 and the transport assist apparatus 100 in perpendicular directions. The pivotal support unit 103 pivots to move forward from below the crotch of the user 150, centered on the pivot shaft 108 of the drive unit 105 and maintained in contact with the floor surface, as the user 150 crouches down lower. Since the pivotal support unit 103 operates in this way, stability can be increased more than when assisting an action of the user 150 with the straight-move support unit 102. In the state in which the user 150 crouches, the backpack 101 is not fixed to the straight-move support unit 102 but can freely pivot about the drive unit 105 as the pivot shaft 108. Therefore, when the straight-move support unit 102 is perpendicular to the floor surface, the user 150 can adopt a crouching posture, and a degree of freedom is maintained about the posture of the user 150. At the time of performing a lifting action, the user is prevented from being hindered from exerting power due to an unnatural posture.

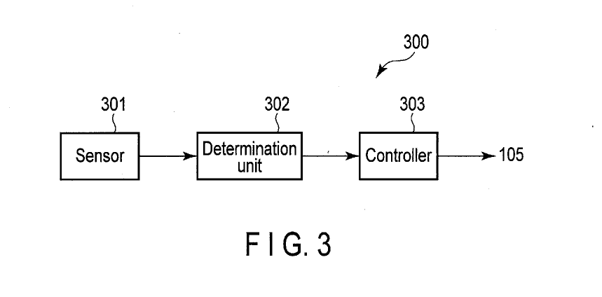

Next, a control apparatus which controls the drive unit 105 will be described with reference to the block diagram of FIG. 3. A control apparatus 300 may be integrated with the transport assist apparatus 100 or may be installed in a manner that remote operation is available from a distant place from the transport assist apparatus 100.

The control apparatus 300 includes a sensor 301, a determination unit 302, and a controller 303.

The sensor 301 is, for example, at least one of an acceleration sensor which measures an acceleration of the drive unit 105 in a perpendicular direction, a force sensor which measures a load applied to a drive motor, and a myogenic-potential sensor which measures a myogenic potential of the user 150. The sensor 301 obtains sensor values from these sensors.

The determination unit 302 receives a sensor value from the sensor 301, and determines whether the sensor value is not smaller than a threshold or not. The determination unit 302 generates a drive signal if the sensor value is not smaller than the threshold. When a plurality of sensors are used, a drive signal is generated if any one of a plurality of sensor values is not smaller than the threshold.

The controller 303 receives the drive signal from the determination unit 302, and controls the magnitude of torque and operating speed of a drive motor comprised in the drive unit 105 in accordance with the drive signal. Specifically, for example, controls are performed in a manner that a timing for a crouching operation is detected depending on the drive signal, and the drive motor of the drive unit 105 is controlled to a preset height, thereby to decrease the height of the straight-move support unit 102. A further control is considered to control the magnitude of torque and operating speed of the drive motor in a manner that output assists a lift-up operation, depending on at least one of load weights of the target person and object or depending on an instruction from the user.

Controls may be performed without using the control apparatus 300, when the drive unit 105 is driven to attain the magnitude, operating speed, and position which are predetermined by an instruction from the user 150 (through switch control by the user).

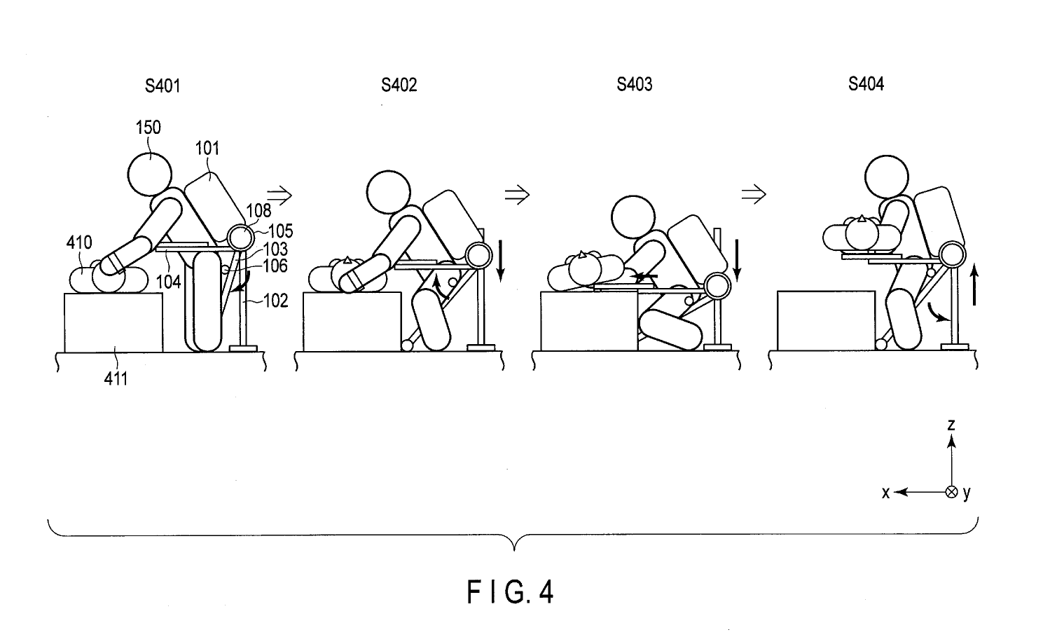

Next, example operations of the transport assist apparatus 100 will be described with reference to FIG. 4.

The example of FIG. 4 shows a series of operations until a target person 410 who lies on a bed 411 is lifted by the user 150 with use of the transport assist apparatus 100.

In an initial state, the user 150 who carries the backpack 101 on their back stands next to the bed 411, and expands the straight-move support unit 102 and the pivotal support unit 103 so as to extend in a perpendicular downward direction, thereby resting an end of the straight-move unit 102 on the floor surface. Further, the arm support unit 104 is made to expand to the forward side of the user 150.

In Step S401, the pivotal support unit 103 pivots in the expanding direction and expands so as to position the pivotal support unit 103 ahead of the straight-move support unit 102. At this time, the other end (grounded part) of the pivotal support unit 103 may be in contact with the floor surface or may float above the floor surface.

In Step S402, the user 150 adopts a crouching action. In accordance with the crouching action, the drive unit 105 moves in a perpendicular downward direction about the straight-move support unit 102 as a support rod. In other words, the drive unit 105 drives the straight-move support unit 102 in a perpendicular upward direction, maintaining the straight-move unit 102 on the ground. Alternatively, the user 150 may manually manipulate a crouching operation through a switch attached to the transport assist apparatus 100, a switch extended from the transport assist apparatus 100, or a switch wirelessly connected to the transport assist apparatus 100. Still alternatively, the user 150 may input a voice into a microphone, and the crouching operation may be triggered by a predetermined word by subjecting a voice signal obtained through the microphone to a voice recognition processing.

Further alternatively, the crouching operation may be triggered by a change amount of an acceleration sensor attached to the transport assist apparatus 100. For example, movement of the transport assist apparatus 100 in the perpendicular downward direction may be detected. The drive unit 105 may drive the straight-move support unit 102 in the perpendicular upward direction if a sensor value of the acceleration sensor is not smaller than a threshold. Still alternatively, a myogenic-potential sensor may be attached to the user 150, and a change amount of the myogenic-potential sensor may trigger the crouching operation. For example, an action of a user 150 bending a knee may be detected from a change amount of the myogenic-potential sensor. If a sensor value of the myogenic-potential sensor is not smaller than a threshold, the drive unit 105 may drive the straight-move support unit 102 in the perpendicular upward direction. Still alternatively, a load amount of the drive motor may trigger the crouching operation. For example, when the user 150 applies an external force to move the drive unit 105 in the perpendicular downward direction, the drive unit 105 may drive the straight-move support unit 102 in the perpendicular upward direction if the load amount of the drive motor detected by the force sensor is not smaller than a threshold.

In accordance with an operation of the drive unit 105 moving down in the perpendicular downward direction, the pivotal support unit 103 pivots in the expanding direction. The pivoting amount thereof may be set on a geometrical basis, or pivoting may be controlled so as to maintain a constant downward torque. Otherwise, free pivoting is available. At this time, the seat 106 moves to a position where the user 150 can sit, in accordance with operation of the pivotal support unit 103, and the user 150 can therefore sit thereon.

In Step S403, when a height which is suitable for the user 150 to load the target person 410 is reached, the drive unit 105 stops perpendicular downward movement. A trigger to stop this movement may be detection of a change amount of a value of the force sensor, acceleration sensor, or the myogenic-potential sensor as described above. Alternatively, setup may be performed to stop at a predetermined height or to stop upon an instruction from the user 150.

When loading the target person 410, the arm support units 104 are extended forward to load the target person 410. In the example of FIG. 4, the target person 410 is loaded onto the arms of the user 150. Another method is available in which the target person 410 is loaded onto the arm support units 104 and the user 150 supports the target person 410 by holding the person from above.

Step S404 performs an operation (lift-up operation) in which the drive unit 105 moves up in the perpendicular upward direction in relation to the straight-move support unit 102 as a support rod, in accordance with a lift-up action of the user 150, i.e., the drive unit 105 drives the straight-move support unit 102 down in the perpendicular downward direction. As a trigger for a stand-up operation, the same trigger as that for the crouching operation may be employed except that a detection direction and an operation direction are reversed. In accordance with driving of the drive unit 105 in the perpendicular upward direction, the pivotal support unit 103 pivots in the storing direction. As for the pivoting amount at this time, the pivotal support unit 103 may geometrically pivot so as to maintain the straight-move support unit 102 to be perpendicular, or may freely pivot.

The torque of the drive motor applied to the straight-move support unit 102 and the pivotal support unit 103 and the operating speed thereof during the lift-up operation may be generated as a predetermined torque or as a torque corresponding to a weight to be lifted up. Alternatively, a force which the user 150 applies may be estimated from the myogenic-potential sensor or the force sensor, and a torque may be generated supplementarily depending on the estimation. Otherwise, the torque may be generated so as to operate at a predetermined speed. Further, a speed at which a person needs to be lifted up may be measured with an acceleration sensor, and a torque may be generated so as to operate at such speed. Acceleration and deceleration of the drive motor may be controlled in the same manner as described above.

The lift-up operation may be stopped when an initial position of the standing state is reached. In place of the initial position, the lift-up operation may be stopped upon detection of an instruction from the user 150 or a change amount of a sensor. Then, the operations of the transport assist apparatus 100 are terminated.

In the crouching operation of the user 150 in Steps S401 and S402, the drive motor is driven to perform the crouching operation. Before loading the target person 410, the drive unit 105 may be moved down in the perpendicular downward direction in accordance with a crouching action of the user 150, without driving the drive motor, thereby to pivot the pivotal support unit 103 in the expanding direction. In this manner, crouching is quickly achieved, from which to the user can transit to a posture for lifting up the target person 410.

Depending on the posture of the user 150, it may be assumed that the user is more relaxed and exerts more power when the user bends forward or backward than when the user stands up perpendicularly. Therefore, the driving direction of the straight-move support unit 102 is not always limited to perpendicular vertical directions and the straight-move support unit 102 may be able to drive in a direction towards or away from the floor surface.

Next, an storing operation of storing the transport assist apparatus 100 will be described with reference to FIG. 5.

In Step S501, the arm support units 104 are manually or automatically pivoted so as to direct an edge of the arm support unit 104 in the perpendicular upward direction, and are stored in the backpack 101 to be approximately parallel to the backpack 101. The present embodiment supposes a case in which the arm support units 104 are stored in lateral sides of the backpack 101. However, the structure may be configured to further fold and store the arm support units 104 toward the center of the backpack 101. In order to maintain the arm support units 104 contracted or held up, a latch structure may be employed or the arm support units 104 may be held by friction of sliding surfaces or may be fixed with screws.

In Step S502, the pivotal support unit 103 is pivoted in the retracting direction to be stored in the backpack. For example, as shown in FIG. 2, if the straight-move support unit 102 has a structure in which each horizontal member is connected to end parts of two perpendicular members, the pivotal support unit 103 can be anticipated to collide and interfere with the straight-move support unit 102. Therefore, the pivotal support unit 103 may be configured by an expandable/contractable member and may be contracted so as not to interfere with the straight-move support unit 102 at the time of retraction. Further, if the seat 106 is hung from the drive unit 105, the seat 106 may be stored in the backpack 101 or may be fixed to the bottom surface of the backpack 101 or the drive unit 105.

In Step S503, the drive unit 105 drives the pivotal support unit 105 in the perpendicular upward direction and stores the unit 105 in the backpack 101. Alternatively, the structure may be configured to store the straight-move support unit 102 by pivoting in the same manner as the pivotal support unit 103.

Thus, since the arm support unit 104, pivotal support unit 103, and straight-move support unit 102 are stored in the backpack 101, space-saving is improved and portability is facilitated. The storing method is not limited to the descriptions above but may be performed in any order.

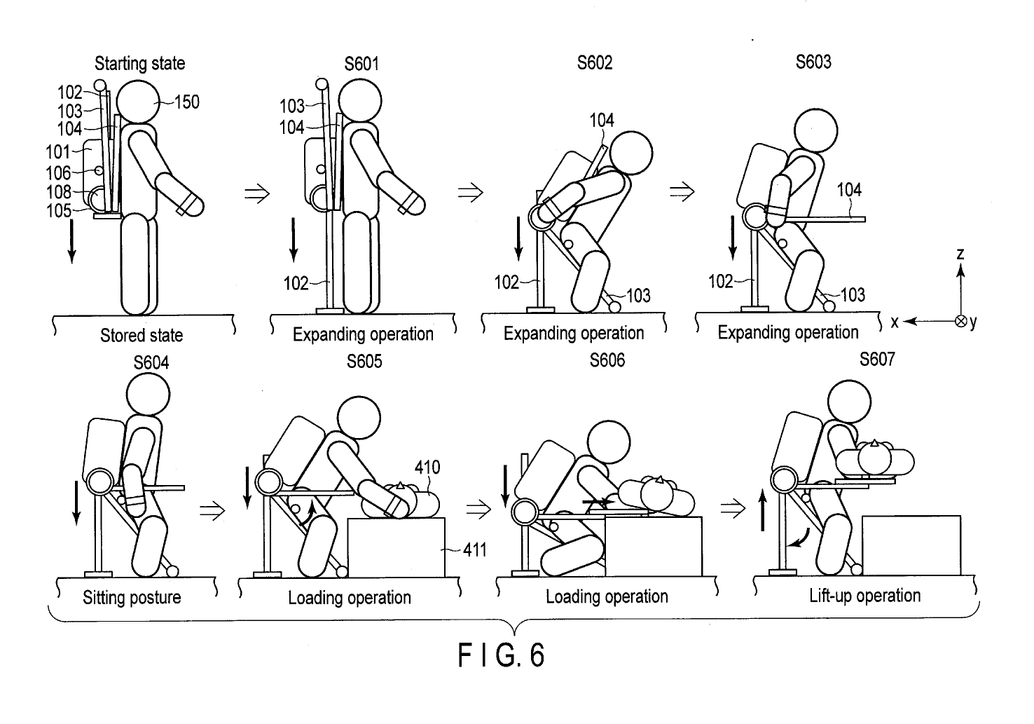

Next, the flow of a series of operations from the stored state of the transport assist apparatus 100 up to the lift-up operation will be described with reference to FIG. 6.

A start state is the same stored state as shown in Step S503 in FIG. 5.

In Step S601, the straight-move support unit 102 is expanded from the stored state of the transport assist apparatus 100. As a trigger for the expanding operation of the straight-move support unit 102, the user 150 may manually manipulate the straight-move support unit 102 through a switch attached to the transport assist apparatus 100, a switch extended from the transport assist apparatus 100, or a switch wirelessly connected to the transport assist apparatus 100. Otherwise, the straight-move support unit 102 may be instructed to expand through voice recognition processing.

Alternatively, the expanding operation may be triggered by a change amount of an acceleration sensor attached to the transport assist apparatus 100. For example, when movement of the transport assist apparatus 100 in the perpendicular downward direction is detected, the drive unit 105 may drive the straight-move support unit 102 down in the perpendicular downward direction. Still alternatively, a myogenic-potential sensor may be attached to the user 150, and a change amount of the myogenic-potential sensor may trigger the crouching operation. For example, when an action of bending a knee of the user 150 may be detected from a change amount of the myogenic-potential, the drive unit 105 may drive the straight-move support unit 102 down in the perpendicular downward direction. Still alternatively, a load amount of the motor may trigger the expanding operation. For example, when the user 150 applies an external force to move the straight-move support unit 102 down in the perpendicular downward direction, the straight-move support unit 102 may be driven down in the perpendicular downward direction.

Further, the straight-move support unit 102 stops when the straight-move support unit 102 is brought into contact with the floor surface. Contact with the floor surface may be detected by providing a switch on a grounding surface of the straight-move support unit 102, and operation may be stopped when the user 150 presses the switch. Alternatively, a distance sensor may be faced down from the straight-move support unit 102, to measure a distance to the floor surface. When the distance is measured to be zero, grounding may be determined. Still alternatively, a force sensor may be provided to detect a load, or grounding may be detected depending on a load of the motor. Alternatively, the operation may be stopped when a pre-input distance is reached. Still alternatively, the operation of the straight-move support unit 102 may be stopped upon an apparent artificial manipulation (by a switch attached to the apparatus or by a voice instruction or voice recognition).

In Step S602, a control in which Step S502 is reversed is performed, and the pivotal support unit 103 is pivoted in the expanding direction so that the pivotal support unit 103 faces down in the perpendicular downward direction.

In Step S603, a control in which Step S501 is reversed is performed, and the arm support unit 104 is pivoted in the expanding direction so that the arm support unit 104 faces down in the horizontal direction.

In Step S604, a state in which the user 150 sits on the seat 106 is shown as a sitting posture. Thus, the user 150 can rest and further perform the crouching operation from the sitting posture, to transit to an operation to load the target person 410.

Steps S605 to S607 are the same as the operations from Steps S402 to S404 shown in FIG. 4, and descriptions thereof will be therefore omitted herefrom.

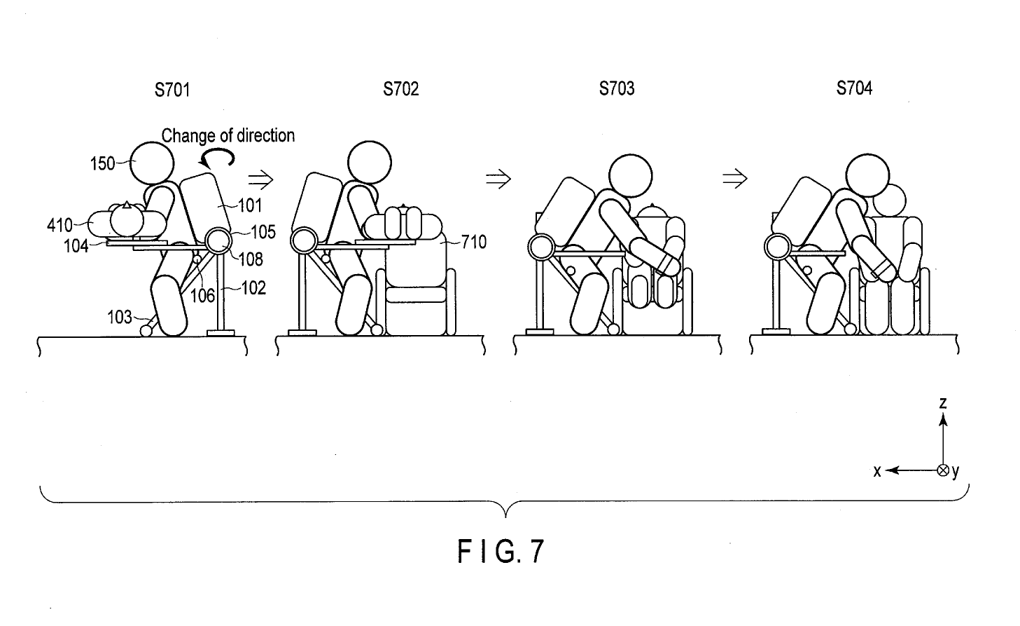

Next, an example of transferring operation of the transport assist apparatus 100 will be described with reference to FIG. 7.

FIG. 7 shows an example of transferring the target person 410 down onto a chair 710 from a state in which the target person 410 is loaded on the transport assist apparatus 100. Transferring is not limited to this example and even transferring which requires crouching with the target person loaded can be performed.

In Step S701, the straight-move support unit 102 pivots in a horizontal direction about the straight-move support unit 102 as a pivot axis from the state in which the target person is lifted up as shown in Step S607. At this time, the grounding part of the pivotal support unit 103 may be a caster which can freely pivot, or may have a structure in which the grounding part leaves the floor surface so as to float when pivoting in the horizontal direction and is grounded again when the pivoting stops.

In Step S702, pivoting is stopped when a position where the target person 410 can be made to sit on the chair 710 is reached. Start and stop of the pivoting and the pivoting speed thereof may be freely controlled by the user 150.

In Step S703, the target person 410 is made to sit on the chair 710. At this time, in order to let the target person 410 sit on the chair 710, the drive unit 105 moves down in the perpendicular downward direction in accordance with a crouching action of the user 150, if required. That is, a control is performed to drive the straight-move support unit 102 in the perpendicular upward direction, with an end of the straight-move support unit 102 grounded. At this time, in order to reduce the burden of a load weight applied to the user 150, the magnitude of the torque of the motor is controlled to assist in supporting the load weight.

In Step S704, the target person 410 is made to sit down on the chair 710, and the drive unit 105 is thereafter controlled to reach an initial position. Control to return to the initial position may be performed by the method as described with reference to Step S404. The transferring operation of the transport assist apparatus 100 is then terminated.

According to the first embodiment described above, the user carries the backpack on their back, and the drive unit connected to the backpack drives the straight-move support unit. Therefore, the user and the transport assist apparatus cooperate integrally together, and the apparatus supports a load weight while the user maintains their posture. When the user lifts up a target person or object from a state in which the user crouches down, or when the user sets down the target person or object from a lifted-up state, the user can maintain a posture in which the user can exert their power while supporting a load weight applied to the user even in an unnatural posture, such as half-sitting. Accordingly, there is a reduction in the burden of the load weight which is applied to the user when lifting the target person or object up or down. Further, the straight-move support unit, pivotal support unit, and arm support units are configured to be storable in the backpack. Therefore, the apparatus can be downsized and portability is facilitated. Still further, a battery such as a secondary battery which activates the drive motor of the drive unit is stored in the backpack. More downsizing is thus achieved, and portability is further improved. Further, the configuration of the drive unit can be partially used in common with driving of the straight-move support unit and a rotation assist part. The apparatus can therefore be compact. Further, since the pivotal support unit is pivoted from below the crotch, a movable range of legs can be ensured, and the transport assist apparatus can be balanced more stably.

### Second Embodiment

In the first embodiment, when the user carries the transport assist apparatus on their back performs a crouching operation and a stand-up operation, if the driving speed of the transport assist apparatus is slow, the user may in an unnatural position or posture for a long time. Therefore, the fatigue of the user may increase or the user may be hindered from exerting their power. Further, in an actuator such as a motor in general, a high torque and a high speed are not compatible. Therefore, to realize a high-speed and high-torque operation that can output equivalent force at an equivalent operation speed to those of the user, a high-power actuator is required. However, a high-power actuator has a problem that the user is burdened because the actuator itself or a power source (such as a battery) of the actuator is large and heavy.

In the second embodiment, a power accumulation unit is used to increase the driving speed of the transport assist apparatus in the stand-up operation. As a result, the transport assist apparatus can operate at an equivalent operation speed to that of the user and can reduce the burden applied to the user.

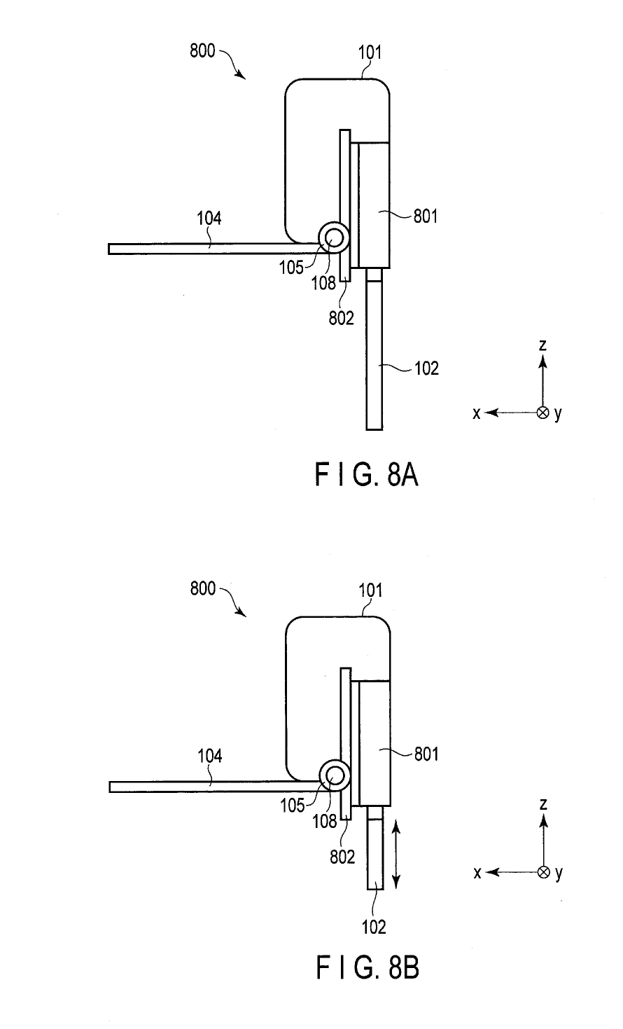

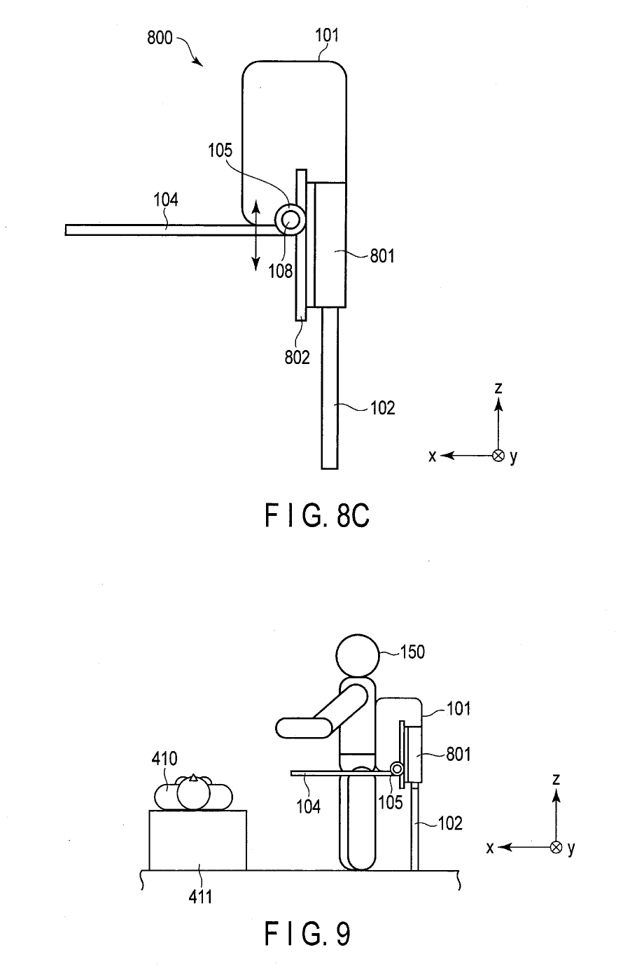

The transport assist apparatus according to the second embodiment will be described with reference to FIGS. 8A, 8B and 8C.

The transport assist apparatus 800 according to the second embodiment includes a backpack 101, a straight-move support unit 102, an arm support unit 104, a drive unit 105, a power accumulation unit 801 and a rack gear 802.

The backpack 101, the arm support unit 104 and the drive unit 105 are the same as those of the first embodiment; therefore, descriptions of these elements are omitted. In the first embodiment, the rack gear included in the drive unit 105 is not shown; however, in the second embodiment, the rack gear 802 is shown in drawings.

FIG. 8A shows an initial state (a first state) of the transport assist apparatus 800. In the second embodiment, the power accumulation unit 801 is assumed to be formed of a gas spring. The power accumulation unit 801 is not limited thereto but may be formed of a coil spring, a low-load spring, or the like.

The power accumulation unit 801 is connected to the backpack 101 and the rack gear 802 which fits in a part of the drive unit 105. An end of the straight-move support unit 102, which does not rest on a floor surface, can be inserted into the power accumulation unit 801. Alternatively, the power accumulation unit 801 may have a configuration wherein an end of a ground side, which is not connected to the backpack 101, is placed on the ground.

FIG. 8B shows a state (a second state) in which force for movement in a direction away from the floor surface is accumulated in the force accumulation unit 801. For example, when a user who carries the backpack 101 on their back is crouching in a perpendicular downward direction, the straight-move support unit 102 is inserted into the force accumulation unit 801. As a result, the force accumulation unit 801 accumulates force. In this embodiment, the straight-move support unit 102 functions as a rod of the gas spring, and the gas is compressed as the straight-move support unit 102 is inserted into the force accumulation unit 801. Accordingly, force for movement in a direction away from the floor surface is accumulated.

The force accumulation unit 801 includes a lock mechanism to release or stop the accumulated force at a desired position.

FIG. 8C shows a state (a third state) in which the force is released from the state shown in FIG. 8B. For example, when a user who carries the backpack 101 on their back stands up in a perpendicular upward direction, the force accumulation unit 801 unlocks the lock mechanism and releases the accumulated force. Thus, since force for movement in a perpendicular upward direction can be generated, the force can assist the lift-up operation of the user and increase the stand-up speed.

Next, examples of the crouching operation and the lift-up operation of the transport assist apparatus according to the second embodiment will be described with reference to FIGS. 9, 10 and 11.

In the example of FIG. 9, a target person 410 lies on a bed 411. The target person 410 is lifted up by the user 150 with use of the transport assist apparatus 800 in a series of operations, as well as the example of FIG. 4.

First, when performing a crouching operation, the user 150 unlocks the lock mechanism of the force accumulation unit 801. The lock mechanism may be locked or unlocked directly by the user or, may be controlled in association with a trigger to start a crouching operation as explained above in connection with step S402 shown in FIG. 4.

The straight-move support unit 102 functioning as a support rod is pushed into the force accumulation unit 801 in accordance with the weight of the user 150, and force is accumulated in the force accumulation unit 801. The force in the force accumulation unit 801 is set such that, when the lock mechanism of the force accumulation unit 801 is unlocked, the force in the perpendicular downward direction due to the weight of the user in the crouching operation is greater than the force in the perpendicular upward direction accumulated in the force accumulation unit 801.

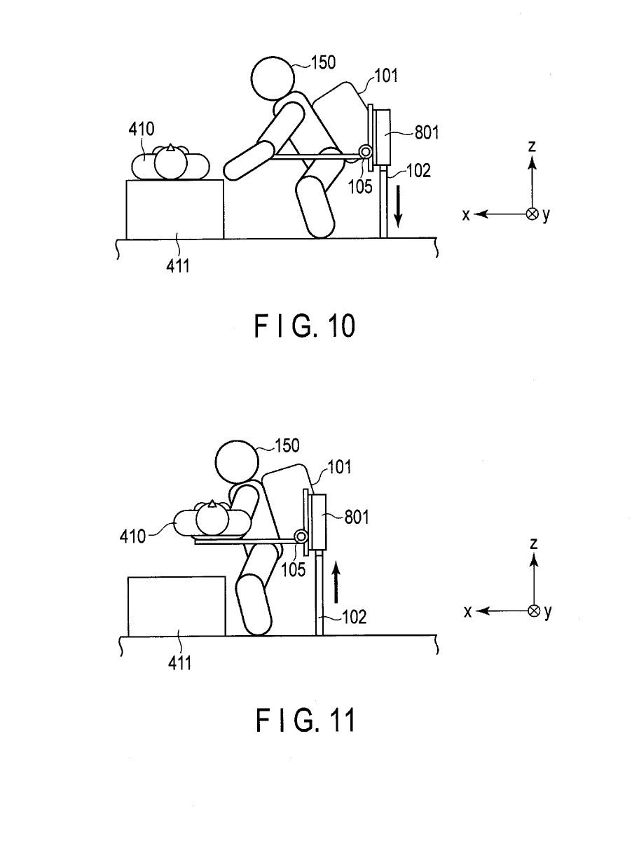

Next, a case of stopping the crouching operation will be described with reference to FIG. 10.

A trigger to stop the movement in step S403 shown in FIG. 4 may be used to stop the crouching operation. Therefore, a description of the trigger is omitted here. After the crouching operation is stopped, if fine adjustment of positioning is performed, for example, to adjust the arm support units 104 to the height of a bedside, the height in the vertical direction is preferably adjusted by moving the drive unit 105, while the lock mechanism of the force accumulation unit 801 is kept locked. Fine adjustment can be made in accordance with of the gear ratio of the drive unit 105.

Next, a lift-up operation will be described with reference to FIG. 11.

The user 150 performs a lift-up operation by standing up while loading the target person on the arm support units 104 or the arms of themself. A trigger to start the lift-up operation is the same as that in the first embodiment.

When performing the lift-up operation, the lock mechanism of the force accumulation unit 801 is unlocked and the transport assist apparatus 800 is operated by using a trigger to start the stand-up operation in Step S404 shown in FIG. 4. In the lift-up operation, the straight-move support unit 102 functions as a support rod and the apparatus can lift up the target person 410 in the perpendicular upward direction by muscular power of the user standing up, the force accumulated in the force accumulation unit 801 and the drive of the drive unit 105. The push-up speed of the straight-move support unit 102 by release of force accumulated in the force accumulation unit 801 is set to the same speed as the stand-up operation of the user in advance. The drive unit 105 is driven at the same speed as the operation speed of the user in the lift-up operation. When the user 150 feels that the target person reaches a desired height, they stops the drive unit 105 and locks the force accumulation unit 801 by the lock mechanism.

Next, a set-down operation will be described.

In accordance with the crouching operation of the user 150, the drive unit 105 moves in the perpendicular downward direction along the straight-move support unit 102 functioning as a support rod. Drive may be started in the same manner as in the first embodiment in the method as described above using, as a trigger for starting the set-down operation, a switch, a voice recognition process by a microphone, a change amount detected by an accelerator sensor (for example, detecting that the user is going to move in a crouching direction), a change amount detected by a myogenic-potential sensor (for example, detecting a bending motion of a knee), a change amount of a load of the drive motor (for example, detecting that external force to move the drive unit 105 down is applied), a load amount of a force sensor (for example, detecting that force applied to the force sensor increases), etc. Stopping the set-down operation may be triggered in the same manner as stopping the crouching operation.

The units of the transport assist apparatus 800 may be stored in the same manner as in the first embodiment.

In the second embodiment described above, the force accumulation unit 801 includes a gas spring, and accumulates force by insertion of the straight-move support unit 102 as a rod into the force accumulation unit 801. However, the force accumulation unit is not limited to this configuration. For example, the force accumulation unit 801 may be arranged in parallel with the straight-move support unit 102 of the transport assist apparatus 100 of the first embodiment, and force may be accumulated in the force accumulation unit 801 in accordance with the crouching operation of the user.

If the force accumulation unit 801 includes a low load spring, the force accumulation unit 801 may be connected to an end of the straight-move support unit 102, which does not rest on a floor surface. In this configuration, force in a direction away from the floor surface is accumulated (the low load spring is expanded) by the crouching operation of the user and the force accumulation unit 801 is released (the low load spring is restored) in a lift-up operation.

In other words, the force accumulation unit 801 may be arranged or connected in any way, so far as the force accumulation unit 801 can accumulate force in accordance with a crouching operation of the user and release the accumulated force in accordance with a stand-up operation of the user.

According to the second embodiment described above, the force accumulated by the crouching operation of the user in the force accumulation unit is released in the lift-up operation. Thus, the second embodiment can increase the speed of the lift-up operation and the set-down operation of the user and can assist the transport operation of the user.

### Modification of Second Embodiment

A modification of the second embodiment differs from the second embodiment in that one end of a rack gear 802 is connected to a straight-move support unit 102.

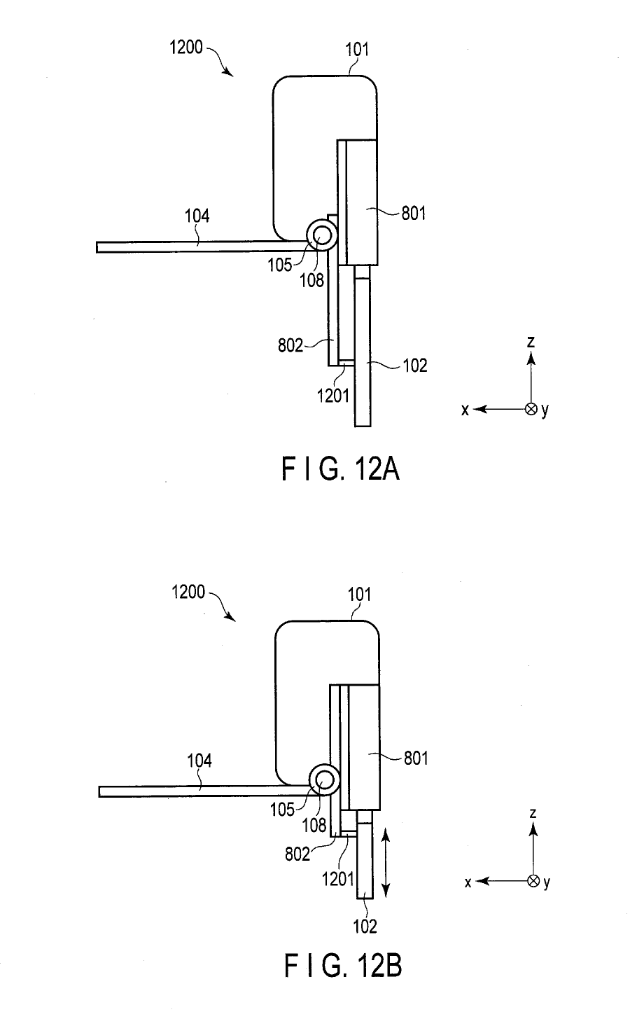

A transport assist apparatus according to the modification of the second embodiment will be described with reference to FIG. 12A and FIG. 12B. FIG. 12A shows an initial state (a first state) of the transport assist apparatus according to the modification of the second embodiment. FIG. 12B shows a state in which force is accumulated in the transport assist apparatus (a second state) according to the modification of the second embodiment.

The transport assist apparatus 1200 according the modification of the second embodiment includes a backpack 101, a straight-move support unit 102, an arm support unit 104, a drive unit 105, a force accumulation unit 801, a rack gear 802 and a connecting member 1201.

The backpack 101, the straight-move support unit 102, the arm support unit 104 and the force accumulation unit 801 are the same as those of the second embodiment; therefore, descriptions of these elements are omitted.

A portion of the rack gear 802 in a floor surface side is connected to a portion of the straight-move support unit 102 on a floor surface side via the connecting member 1201. A connecting position of the connecting member 1201 may be determined appropriately in accordance with the amount of crouching of the user who carries the transport assist apparatus 1200. In other words, the connecting position may be a position where the connecting member 1201 may not be brought into contact with the force accumulating unit 801 until the user completely crouches down.

Since one end of the rack gear 802 in a floor surface side is connected to the straight-move support unit 102, the force accumulation unit 801 moves down in a perpendicular downward direction as the drive unit 105 drives in the perpendicular downward direction. Accordingly, the straight-move support unit 102 is pushed into the force accumulation unit 801, thereby accumulating force.

The drive unit 105 includes a ratchet (not shown) as a transmission mechanism between a motor and a pinion gear included in the drive unit 105, and transmits power only in one direction. The rotation direction of the ratchet changes in accordance with the direction of operation; thus, the ratchet is utilized to drive the drive unit 105 for up and down operations and accumulate force in the force accumulating unit 801. For example, when the user performs a lift-up operation in the perpendicular upward direction, rotation of the drive unit 105 in the perpendicular upward direction (clockwise direction) can release the force accumulated in the force accumulation unit 801 by freeing the rotation by the ratchet. The ratchet may be a torque limiter which limits transmission only from an input shaft to an output shaft.

The gear of the drive unit 105 may be changed to a gear with a high speed-reduction gear ratio for drive at a low speed and high torque, although the speed in a stand-up operation is reduced in this case. As the drive unit 105 drives, a sum of the amount of drive of the drive unit 105 and the fore in the force accumulation unit 801 can be used for the lift-up operation in addition to the muscle force of the user in the lift-up operation. Therefore, the burden applied to the user can be reduced. Similarly, in the set-down operation, the gear of the motor of the drive unit 105 may be changed to a gear with a high speed-reduction ratio for drive at a low speed and high torque.

According to the modification of the second embodiment described above can assist the lift-up operation and the set-down operation of the user as well as the second embodiment.

While certain embodiments have been described, these embodiments have been presented by way of example only, and are not intended to limit the scope of the inventions.

Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A transport assist apparatus, comprising:
a backpack;
a straight-move support unit connected to the backpack and comprising a support member configured to be driven so as to make an end of the support member contact a floor surface; and
a drive unit connected to the backpack and the straight-move support unit and configured to drive the support member in a direction of moving the end toward the floor surface in accordance with lifting up of at least one of a target person and a target object by a user, or in a direction of moving the end away from the floor surface in accordance with setting down of the at least one of the target person and the target object by the user.

2. The apparatus according to claim 1, wherein the drive unit comprises a pivot shaft which is pivotable to a forward side or a backward side of the user, and
the apparatus further comprises a pivotal support unit having an end and another end, the end is connected to the drive unit, the other end pivots in centered on the pivot shaft so as to move toward the forward side with the other end contacting the floor surface, or so as to move toward the backward side with the other end contacting the floor surface.

3. The apparatus according to claim 2, wherein the pivotal support unit is expandable and contractable.

4. The apparatus according to claim 2, further comprising a seat where the user sits when lifting up or setting down the at least one of the target person and the target object, the seat being formed on a part of the pivotal support unit.

5. The apparatus according to claim 1, further comprising an arm support unit having an end connected to the drive unit and another end extended to a forward side of the user.

6. The apparatus according to claim 5, wherein the backpack is able to store the straight-move support unit, the pivotal support unit and the arm support unit.

7. The apparatus according to claim 1, further comprising:
at least one of a myogenic-potential sensor configured to measure a myogenic potential of the user, an acceleration sensor configured to measure an acceleration of the drive unit, and a force sensor configured to measure a load applied to the drive unit;
a determination unit configured to determine whether at least one value of the myogenic-potential sensor, the acceleration sensor, and the force sensor is not smaller than a threshold or not; and
a controller configured to control operation of the straight-move support unit when the at least one value is determined to be not smaller than the threshold.

8. The apparatus according to claim 7, wherein the controller controls a magnitude of torque and an operating speed of the drive unit in order to assist the user in lifting up and setting down, in accordance with at least one of a load of the target person and a load of the target object or in accordance with an instruction from the user.

9. The apparatus according to claim 1, further comprising a force accumulation unit connected to at least one of the backpack, the straight-move support unit and the drive unit, and configured to accumulate force for movement in a direction away from the floor surface.

10. The apparatus according to claim 9, wherein the force accumulation unit accumulates the force as the user crouches, and releases the accumulated force as the user lifts up the at least one of the target person and the target object.

11. A transport assist apparatus, comprising:
a backpack;
a straight-move support unit configured to be driven so as to make an end contact a floor surface;
a force accumulation unit connected to the backpack and inserted another end of the straight-move assist unit, and configured to accumulate force for movement in a direction away from the floor surface; and
a drive unit connected to the force accumulation unit and configured to drive the force accumulation unit in a direction of moving the end toward the floor surface in accordance with lifting up of at least one of a target person and a target object by a user, or in a direction of moving the end away from the floor surface in accordance with setting down of the at least one of the target person and the target object by the user.

12. The apparatus according to claim 11, wherein the force accumulation unit accumulates the force as the user crouches, and releases the accumulated force as the user lifts up the at least one of the target person and the target object.

13. The apparatus according to claim 11, further comprising:
a rack gear fitting in a part of the drive unit; and
a connecting member connecting the rack gear and the straight-move assist unit, wherein
the force accumulation unit accumulates the force as the straight-move assist unit is inserted in the force accumulation unit in accordance with drive of the drive unit via the connecting member.
